(19) United States
(12) Patent Application Publication
(10) Pub. No.: US 2026/0249824 A1
(43) Pub. Date: Aug. 27, 2026

(54) BRAKING DEVICE

(71) Applicant: ADVICS CO., LTD., Kariya-shi, Aichi-ken (JP)

(72) Inventors: Kazutoshi YOGO, Kariya-shi, Aichi-ken (JP); Yosuke YAMASOE, Kariya-shi, Aichi-ken (JP); Shota KATO, Kariya-shi, Aichi-ken (JP); Taisuke YAMADA, Toyota-shi, Aichi-ken (JP)

(73) Assignee: ADVICS CO., LTD., Kariya-shi, Aichi-ken (JP)

(21) Appl. No.: 19/165,843

(22) PCT Filed: Mar. 14, 2024
(86) PCT No.: PCT/JP2024/010126

§ 371 Date: Sep. 16, 2025

(30) Foreign Application Priority Data
Mar. 17, 2023 (JP) 2023-043142

(51) Int. Cl. B60T 13/68; B60T 8/171; B60T 8/172; B60T 13/14; B60T 13/62; B60T 13/74

(52) U.S. Cl. CPC B60T 13/686; B60T 8/171; B60T 8/172; B60T 13/148; B60T 13/745; B60T 13/142; B60T 13/62; B60T 2250/00; B60T 2270/402; B60T 2270/404; B60T 2270/82

(57) ABSTRACT

A vehicle braking device includes a first braking portion including an electric cylinder using a first electric motor as a drive source, and a second braking portion including a differential pressure adjustment valve provided in a flow path connected to the wheel cylinder. Hydraulic pressure generated by the electric cylinder is a first braking pressure, and differential pressure adjusted by the differential pressure adjustment valve is a second braking pressure. With a target value of wheel cylinder hydraulic pressure as a target pressure, a control device executes overheat restriction processing of repeating forward and reverse rotation of the first electric motor to hold the first braking pressure at a value below the target pressure and adjusting a valve closing force of the differential pressure adjustment valve to generate the first and second braking pressures to satisfy the target pressure by a sum of the first and second braking pressures.

### TECHNICAL FIELD

This disclosure relates to a braking device.

### BACKGROUND ART

Patent literature 1 discloses an electric piston brake device driven by an electric motor. It is described that the device can restrict overheat of the electric motor while holding a piston position, by performing control of holding the piston position by repeating forward rotation and reverse rotation of the electric motor.

### CITATION LIST

### Patent Literature

PTL 1: German Patent Application Publication No. 102019215313

### SUMMARY

### Technical Problem

When the control of holding the piston position as disclosed in Patent Literature 1 is performed in a state where a hydraulic pressure applied by a piston is increased, a load applied to the electric motor tends to increase. Therefore, when a time for holding the state in which the hydraulic pressure is increased increases, a temperature rise of the electric motor may not be restricted.

### Solution to Problem

A braking device for solving the above problem is a braking device to be applied to a vehicle including a first wheel cylinder, a second wheel cylinder, a first wheel that generates a friction braking force corresponding to a hydraulic pressure in the first wheel cylinder, and a second wheel that generates a friction braking force corresponding to a hydraulic pressure in the second wheel cylinder, the braking device including: a reservoir tank configured to store a brake fluid; a first braking portion including an electric cylinder including a cylinder, a piston, and an electric motor, and configured to adjust the hydraulic pressure in the first wheel cylinder and the hydraulic pressure in the second wheel cylinder by discharging the brake fluid, which is supplied from the reservoir tank, by the piston that moves in accordance with driving of the electric motor; a second braking portion interposed between the first wheel cylinder and the first braking portion and configured to adjust the hydraulic pressure in the first wheel cylinder by the brake fluid supplied from the first braking portion; and a control device configured to control the first braking portion and the second braking portion. A magnitude of a hydraulic pressure due to pressurization of the brake fluid by the first braking portion is set as a first braking pressure. The second braking portion includes a hydraulic circuit connected to the first wheel cylinder, and a differential pressure adjustment valve that is disposed in a flow path connecting the first braking portion and the hydraulic circuit, is a normally open electromagnetic valve that adjusts a differential pressure between the first braking pressure and a hydraulic pressure in the hydraulic circuit, and is configured to adjust the hydraulic pressure in the hydraulic circuit to be higher than the first braking pressure. When the vehicle is stopped, with a target value for holding the hydraulic pressure in the first wheel cylinder set as a target WC pressure and a differential pressure adjusted by the differential pressure adjustment valve set as a second braking pressure, the control device executes overheat restriction processing of alternately repeating control of rotating the electric motor in a first direction and control of rotating the electric motor in a second direction opposite to the first direction so as to hold the first braking pressure at a value lower than the target WC pressure and adjusting a valve closing force of the differential pressure adjustment valve to generate the first braking pressure and the second braking pressure so as to satisfy the target WC pressure by a sum of the first braking pressure and the second braking pressure.

In the above configuration, in holding the target WC pressure in the specific wheel cylinder when the vehicle is stopped, both the first braking portion and the second braking portion are controlled. Therefore, the hydraulic pressure held by alternately repeating the control of rotating the electric motor in the first direction and the control of rotating the electric motor in the second direction can be reduced to a value obtained by subtracting the second braking pressure from the target WC pressure. By reducing the hydraulic pressure held by the electric cylinder to be low, it is possible to restrict the temperature rise of the electric motor even when the state where the hydraulic pressure in the wheel cylinder is held high continues. Therefore, overheat of the electric motor can be restricted.

### BRIEF DESCRIPTION OF DRAWINGS

FIG. 1 is a schematic diagram illustrating an embodiment of a braking device.

FIG. 2 is a flowchart illustrating a flow of processing executed by a control device provided in the braking device in FIG. 1.

FIGS. 3A to 3D are timing charts illustrating changes over time of a hydraulic pressure of a wheel cylinder when the control device provided in the braking device in FIG. 1 executes overheat restriction processing.

### DESCRIPTION OF EMBODIMENTS

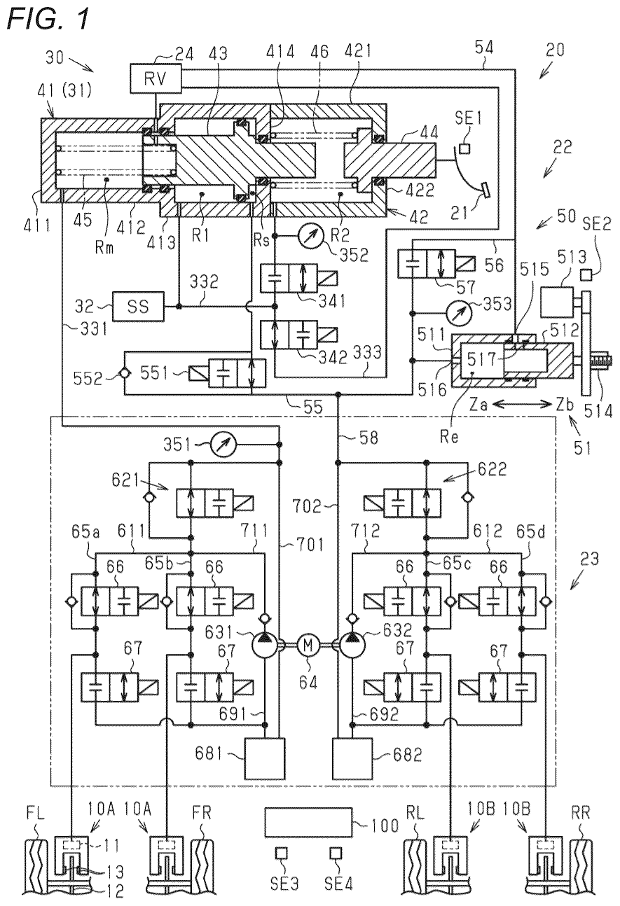

Hereinafter, an embodiment of a braking device will be described with reference to FIGS. 1 to 3D.

FIG. 1 illustrates a braking device 20 of a vehicle. The braking device 20 includes a braking portion capable of applying a braking force to wheels of the vehicle. The braking device 20 includes a first braking portion 50 and a second braking portion 23 as braking portions. The braking device 20 includes a control device 100 capable of controlling the braking portions.

FIG. 1 shows front wheels FL and FR and rear wheels RL and RR as wheels of the vehicle. The vehicle includes a braking operation member 21. The braking operation member 21 can be operated by a driver of the vehicle. An example of the braking operation member 21 is a brake pedal.

The control device 100 is an example of a processing circuit provided in the vehicle. The vehicle may include other processing circuits, not limited to the control device 100. Some functions implemented by the control device 100 may be implemented by the other processing circuits. The processing circuits provided in the vehicle are preferably connected to each other so as to be able to transmit and receive information to and from each other. For example, a configuration in which the processing circuits are connected to an in-vehicle network provided in a vehicle can be adopted. The processing circuits connected to the in-vehicle network can communicate with each other via the in-vehicle network. For example, a detection system such as various sensors provided in the vehicle may be connected to the in-vehicle network. An automated driving control device is an example of another processing circuit.

### Braking Device

The braking device 20 includes braking mechanisms corresponding to the wheels FL, FR, RL, and RR, respectively. A friction braking force can be applied to the wheels FL, FR, RL, and RR by the braking mechanisms. The friction braking force applied to the wheels FL, FR, RL, and RR by the braking mechanisms can be adjusted by the braking device 20. FIG. 1 illustrates, as braking Mechanisms, Front-Wheel Braking Mechanisms 10A corresponding to front wheels FL and FR of the wheels and rear-wheel braking mechanisms 10B corresponding to rear wheels RL and RR of the wheels.

An example of the braking device 20 is a hydraulic braking device. For example, the braking device 20 includes a reservoir tank 24 that stores a brake fluid and a hydraulic pressure generation device 22. An example of the hydraulic pressure generation device 22 is a so-called brake-by-wire hydraulic pressure generation device. The hydraulic pressure generation device 22 is capable of generating a hydraulic pressure according to an operation amount of the braking operation member 21. The hydraulic pressure generation device 22 includes a master device 30 and the first braking portion 50. The master device 30 is capable of supplying the brake fluid to the second braking portion 23. The first braking portion 50 is capable of supplying the brake fluid to the master device 30 and the second braking portion 23.

### Braking Mechanism

The front-wheel braking mechanisms 10A and the rear-wheel braking mechanisms 10B will be described. Each front-wheel braking mechanism 10A includes a wheel cylinder 11 to which the brake fluid is supplied, a rotary plate 12 that rotates integrally with the corresponding wheel, and a friction material 13 that moves relative to the rotary plate 12 in a plate thickness direction of the rotary plate 12. The front-wheel braking mechanism 10A is configured to strongly press the friction material 13 against the rotary plate 12 as a WC pressure Pwc, which is a hydraulic pressure in the wheel cylinder 11, increases. Similarly to the front-wheel braking mechanism 10A, each rear-wheel braking mechanism 10B includes the wheel cylinder 11, the rotary plate 12, and the friction material 13. With the braking mechanisms, as the WC pressure Pwc increases, the friction braking force applied to the wheels FL, FR, RL, and RR is increased.

In the braking device 20 of the embodiment, the front-wheel braking mechanism 10A and the rear-wheel braking mechanism 10B are configured to satisfy the following relationship. A magnitude of the braking force generated with respect to the WC pressure Pwc in the front-wheel braking mechanism 10A is larger than a magnitude of the braking force generated with respect to the WC pressure Pwc in the rear-wheel braking mechanism 10B. Specifically, when the WC pressure Pwc in the front-wheel braking mechanism 10A is equal to the WC pressure Pwc in the rear-wheel braking mechanism 10B, the braking force applied to the front wheels FL and FR is larger than the braking force applied to the rear wheels RL and RR.

Among the plurality of wheel cylinders provided in the vehicle, the wheel cylinder 11 provided in the front-wheel braking mechanism 10A corresponds to a first wheel cylinder. That is, the wheel cylinders 11 for the front wheels FL and FR correspond to first wheel cylinders. The left front wheel FL and the right front wheel FR correspond to first wheels.

Among the plurality of wheel cylinders included in the vehicle, the wheel cylinder 11 provided in the rear-wheel braking mechanism 10B corresponds to a second wheel cylinder. That is, the wheel cylinders 11 for the rear wheels RL and RR correspond to second wheel cylinders. The left rear wheel RL and the right rear wheel RR correspond to second wheels.

### Master Device

An example of the master device 30 includes a master cylinder 31, a stroke simulator 32, a plurality of flow paths 331, 332 and 333 connected to the master cylinder 31, and a plurality of control valves 341 and 342 that control flow of the brake fluid. The stroke simulator 32 can generate a reaction force corresponding to the operation amount of the braking operation member 21.

The master cylinder 31 includes a main cylinder 41 and a cover cylinder 42. The master cylinder 31 includes a master piston 43 and an input piston 44. The master cylinder 31 includes a master spring 45 that applies a force to press the master piston 43, and an input spring 46 that applies a force to press the input piston 44. The master piston 43 and the input piston 44 can move relative to the main cylinder 41 and the cover cylinder 42.

An example of the master cylinder 31 will be described in more detail.

The main cylinder 41 of the master cylinder 31 includes a plate-shaped bottom wall 411 and a first peripheral wall 412 extending from the bottom wall 411 along an axis of the bottom wall 411. The main cylinder 41 further includes a second peripheral wall 413 extending from a rear end of the first peripheral wall 412 along an axis of the first peripheral wall 412, and a first annular wall 414 extending from a rear end of the second peripheral wall 413 toward an axis of the second peripheral wall 413. Each of the first peripheral wall 412 and the second peripheral wall 413 has a tubular shape. A hole into which a rear end portion of the master piston 43 described later is inserted is formed in the first annular wall 414. An inner diameter of the first peripheral wall 412 is smaller than an inner diameter of the second peripheral wall 413.

A master chamber Rm is defined in the main cylinder 41 by the bottom wall 411, the first peripheral wall 412, and the master piston 43. Hereinafter, in the master cylinder 31, among moving directions of the master piston 43, a left side in FIG. 1, that is, a direction in which a volume of the master chamber Rm is reduced is referred to as a “front side”. On the other hand, a direction opposite to the front side among the moving directions of the master piston 43 is referred to as a “rear side”. The rear side is also a direction in which the volume of the master chamber Rm is increased.

In the main cylinder 41, a first fluid chamber R1 is defined by the second peripheral wall 413 and the master piston 43, and a servo chamber Rs is defined by the second peripheral wall 413, the first annular wall 414, and the master piston 43. The master chamber Rm is formed at a position near a front end of the master cylinder 31. The first fluid chamber R1 is formed behind the master chamber Rm. The servo chamber Rs is formed behind the first fluid chamber R1. Inside the main cylinder 41, the master chamber Rm, the first fluid chamber R1, and the servo chamber Rs are not connected to each other. Further, area on which the master piston 43 receives a force in an axial direction, specifically, a rearward direction by a hydraulic pressure in the master chamber Rm is equal to area on which the master piston 43 receives a force in the axial direction, specifically, a forward direction by a hydraulic pressure in the servo chamber Rs.

The cover cylinder 42 of the master cylinder 31 includes a tubular third peripheral wall 421 and a second annular wall 422 extending from a rear end of the third peripheral wall 421 toward an axis of the third peripheral wall 421. The third peripheral wall 421 is attached to the first annular wall 414 such that the axis thereof coincides with the axis of the second peripheral wall 413 of the main cylinder 41. The second annular wall 422 is provided with a hole into which a rear end portion of the input piston 44 described later is inserted.

In the cover cylinder 42, a second fluid chamber R2 is defined by the third peripheral wall 421, the second annular wall 422, and the first annular wall 414 of the main cylinder 41. In the master cylinder 31, the second fluid chamber R2 is formed behind the servo chamber Rs.

The master piston 43 is accommodated in the master cylinder 31 in surface contact with an inner peripheral surface of the first peripheral wall 412, an inner peripheral surface of the second peripheral wall 413, and an inner peripheral surface of the first annular wall 414 of the main cylinder 41. Therefore, when the master piston 43 moves in the axial direction, the master piston 43 slides on the inner peripheral surface of the first peripheral wall 412, the inner peripheral surface of the second peripheral wall 413, and the inner peripheral surface of the first annular wall 414. The rear end portion of the master piston 43 protrudes further rearward relative to the first annular wall 414 and is positioned in the second fluid chamber R2. Here, area on which the master piston 43 receives a force in the axial direction, specifically, in the forward direction by a hydraulic pressure in the second fluid chamber R2 is equal to area on which the master piston 43 receives a force in the axial direction, specifically, in the rearward direction by a hydraulic pressure in the first fluid chamber R1.

The input piston 44 is accommodated in the master cylinder 31 in surface contact with an inner peripheral surface of the second annular wall 422 of the cover cylinder 42. Therefore, when the input piston 44 moves in the axial direction, the input piston 44 slides on the inner peripheral surface of the second annular wall 422. The rear end portion of the input piston 44 protrudes further rearward relative to the second annular wall 422. The braking operation member 21 is coupled to the rear end portion of the input piston 44. Therefore, the input piston 44 moves in a direction of approaching the master piston 43 according to the operation amount of the braking operation member 21. Further, in the second fluid chamber R2, a gap is formed between the input piston 44 and the master piston 43.

The master spring 45 is disposed in the master chamber Rm of the main cylinder 41. The master spring 45 applies, to the master piston 43, a force to press the master piston 43 rearward. Therefore, the master spring 45 is elastically compressed when the master piston 43 moves forward.

The input spring 46 is disposed in the second fluid chamber R2 of the cover cylinder 42. The input spring 46 applies, to the input piston 44, a force to press the input piston 44 rearward. Therefore, the input spring 46 is elastically compressed when the input piston 44 moves forward.

In the master cylinder 31, the master chamber Rm is connected to the reservoir tank 24. Specifically, a portion near a rear end of the master chamber Rm is connected to the reservoir tank 24 via a port formed in the first peripheral wall 412 of the main cylinder 41. Therefore, when the master piston 43 moves forward from an initial position illustrated in FIG. 1, the master chamber Rm and the reservoir tank 24 are not connected. As a result, the hydraulic pressure in the master chamber Rm increases as the master piston 43 moves forward. For example, when the hydraulic pressure in the servo chamber Rs increases, the master piston 43 is moved forward by the hydraulic pressure in the servo chamber Rs. Accordingly, the hydraulic pressure in the master chamber Rm increases.

The first flow path 331 connects the master chamber Rm and the second braking portion 23. That is, the first flow path 331 is a flow path that connects some of the plurality of wheel cylinders 11 with the master chamber Rm. Specifically, the first flow path 331 connects the wheel cylinders 11 for the front wheels FL and FR, which are corresponding to the first wheel cylinders, with the master chamber Rm. The second flow path 332 connects the first fluid chamber R1 and the second fluid chamber R2. The third flow path 333 connects the reservoir tank 24 and the second flow path 332.

The first control valve 341 is a normally closed electromagnetic valve. The second control valve 342 is a normally open electromagnetic valve. The first control valve 341 is disposed in the second flow path 332 between a connection point with the third flow path 333 and the second fluid chamber R2. The second control valve 342 is provided in the third flow path 333. When the control device 100 of the braking device 20 is operating, the first control valve 341 is opened and the second control valve 342 is closed.

The stroke simulator 32 is disposed between the first fluid chamber R1 and the first control valve 341 in the second flow path 332. For example, the stroke simulator 32 includes therein a piston to which a pressing force is applied from a back surface thereof by a spring. In this case, when the brake fluid flows into the stroke simulator 32 from the second flow path 332 and the piston inside the stroke simulator 32 is displaced against a force of the spring, the stroke simulator 32 generates a hydraulic pressure in the brake fluid in accordance with the displacement of the piston. Illustration of the piston is omitted. Specifically, when the input piston 44 is moved forward by the operation of the braking operation member 21 in a state where the first control valve 341 is opened and the second control valve 342 is closed, a volume of the second fluid chamber R2 decreases by a volume of the input piston 44 entering the second fluid chamber R2. Therefore, the brake fluid flowing out from the second fluid chamber R2 to the second flow path 332 flows into the stroke simulator 32. As a result, the stroke simulator 32 generates the same hydraulic pressure in the second fluid chamber R2 and the first fluid chamber R1 that are connected by the second flow path 332. The area on which the master piston 43 receives a force in the axial direction, specifically, in the forward direction by the hydraulic pressure in the second fluid chamber R2 is equal to the area on which the master piston 43 receives a force in the axial direction, specifically, in the rearward direction by the hydraulic pressure in the first fluid chamber R1. Therefore, in a state where the same hydraulic pressures are generated in the second fluid chamber R2 and the first fluid chamber R1, the master piston 43 is not moved in the axial direction by the hydraulic pressures.

### First Braking Portion

The first braking portion 50 includes an electric cylinder 51 including a first electric motor 513 as a power source. The first braking portion 50 can adjust the WC pressure Pwc by the electric cylinder 51 that operates according to a driving amount of the first electric motor 513. That is, the first braking portion 50 can generate a braking force for the wheels FL, FR, RL, and RR of the vehicle.

An example of the first braking portion 50 will be described.

The first braking portion 50 includes the electric cylinder 51. The first braking portion 50 may include a hydraulic pressure adjustment valve 551 and a check valve 552.

The first braking portion 50 includes a fourth flow path 54 that connects the electric cylinder 51 and the reservoir tank 24. The first braking portion 50 includes a sixth flow path 58 that connects the second braking portion 23 and the electric cylinder 51. The first braking portion 50 includes a fifth flow path 55 that connects the servo chamber Rs of the master cylinder 31 and the sixth flow path 58.

The hydraulic pressure adjustment valve 551 is provided in the fifth flow path 55. The hydraulic pressure adjustment valve 551 is an electromagnetic valve that adjusts a differential pressure between a portion of the fifth flow path 55 closer to the servo chamber Rs than is the hydraulic pressure adjustment valve 551 and a portion of the fifth flow path 55 closer to the electric cylinder 51 than is the hydraulic pressure adjustment valve 551. That is, the hydraulic pressure adjustment valve 551 can adjust the amount of the brake fluid supplied to the servo chamber Rs.

The check valve 552 is provided in parallel with the hydraulic pressure adjustment valve 551 in the fifth flow path 55. The check valve 552 allows the brake fluid to flow through the check valve 552 from the servo chamber Rs toward the electric cylinder 51. On the other hand, the check valve 552 restricts the brake fluid from flowing through the check valve 552 from the electric cylinder 51 toward the servo chamber Rs.

### Electric Cylinder

The electric cylinder 51 provided in the first braking portion 50 is provided between the fourth flow path 54 and the sixth flow path 58. The fourth flow path 54 is connected to an input port 515 of the electric cylinder 51. The sixth flow path 58 is connected to an output port 516 of the electric cylinder 51. The input port 515 and the output port 516 will be described later.

A configuration of the electric cylinder 51 will be described with reference to FIG. 1.

The electric cylinder 51 includes a cylinder 511, a piston 512, the electric motor 513, and a conversion mechanism 514. The piston 512 is slidably provided in the cylinder 511. The first electric motor 513 is the power source of the electric cylinder 51. The conversion mechanism 514 converts a rotational motion of an output shaft of the first electric motor 513 into a linear motion of the piston 512.

An example of the first electric motor 513 is a brushless motor. Coils provided in the first electric motor 513 are, for example, three-phase coils including a U-phase, a V-phase, and a W-phase. The first electric motor 513 is driven by a three-phase alternating current.

The first electric motor 513 includes a drive circuit. The drive circuit is, for example, an inverter circuit that converts a direct current into a three-phase alternating current and supplies the three-phase alternating current to the coils of the first electric motor 513. The drive circuit includes a semiconductor element such as a switching element. As the switching element, an MOSFET, an IGBT, or the like can be adopted.

Inside the cylinder 511, a hydraulic chamber Re into which the brake fluid is introduced is defined by a peripheral wall of the cylinder 511 and the piston 512. A position of the piston 512 inside the cylinder 511 can be changed by driving of the first electric motor 513. Hereinafter, a direction in which a volume of the hydraulic chamber Re is reduced among moving directions of the piston 512 is referred to as a “forward direction Za”. A direction opposite to the forward direction Za among the moving directions of the piston 512 is referred to as a “backward direction Zb”. The backward direction Zb is a direction, among the moving directions of the piston 512, in which the volume of the hydraulic chamber Re is increased.

The input port 515 and the output port 516 are formed in the peripheral wall of the cylinder 511 as ports connecting the hydraulic chamber Re and the outside. A through hole 517 is formed in the piston 512. The through hole 517 is formed at a position allowing the input port 515 and the hydraulic chamber Re to be in communication with each other when the piston 512 is positioned at an end-point position. Accordingly, when the piston 512 is positioned at the end-point position, the hydraulic chamber Re of the cylinder 511 communicates with the fourth flow path 54 via the input port 515 and the through hole 517. That is, the hydraulic chamber Re of the cylinder 511 communicates with the reservoir tank 24 via the input port 515 and the through hole 517. The input port 515 is open when the piston 512 is positioned between the end-point position and an origin position. The end-point position is a position where the piston 512 is moved to an end in the backward direction Zb. The origin position is a position reached when the piston 512 is moved from the end-point position in the forward direction Za by a specified movement amount. The electric cylinder 51 is configured such that the input port 515 is closed by the piston 512 when the piston 512 moves in the forward direction Za from the origin position. Thus, when the piston 512 further moves in the forward direction Za after the input port 515 is closed by the piston 512, the hydraulic pressure in the hydraulic chamber Re increases.

The output port 516 of the cylinder 511 is connected to the second braking portion 23 and the fifth flow path 55 via the sixth flow path 58. The output port 516 is always open regardless of the position of the piston 512. Therefore, in a case where the input port 515 is closed by the piston 512, when the piston 512 moves in the forward direction Za, the brake fluid in the hydraulic chamber Re is discharged from the output port 516 to the outside of the cylinder 511.

As illustrated in FIG. 1, the electric cylinder 51 provided in the braking device 20 does not include a spring that applies a force to press the piston 512 in the backward direction Zb. The electric cylinder 51 may include a spring that applies a force to press the piston 512 in the backward direction Zb.

As illustrated in FIG. 1, the first braking portion 50 includes a release flow path 56 and a release valve 57 disposed in the release flow path 56. The release flow path 56 is a flow path that connects the reservoir tank 24 and the wheel cylinder 11 so as to bypass the electric cylinder 51. A first end portion of the release flow path 56 is connected to the fourth flow path 54, and a second end portion of the release flow path 56 is connected to the sixth flow path 58. Specifically, the release flow path 56 connects a portion between the reservoir tank 24 and the input port 515 in the fourth flow path 54 and a portion between the output port 516 and the second braking portion 23 in the sixth flow path 58. The release valve 57 is a normally closed electromagnetic valve. Therefore, when control of opening the release valve 57 is not performed, the release flow path 56 is closed.

### Second Braking Portion

As illustrated in FIG. 1, the second braking portion 23 includes a second electric motor 64 as a power source. The second braking portion 23 can generate a braking force for the wheels FL, FR, RL, and RR of the vehicle according to a driving amount of the second electric motor 64. The second braking portion 23 is interposed between the first braking portion 50 and the wheel cylinder 11.

An example of the second braking portion 23 will be described.

The second braking portion 23 is a braking actuator capable of individually adjusting the WC pressure Pwc of each of the wheels FL, FR, RL, and RR. The second braking portion 23 includes a first pump 631 and a second pump 632 that discharge the brake fluid. The pumps 631 and 632 are driven by the second electric motor 64.

The second braking portion 23 can increase the WC pressure Pwc without increasing the hydraulic pressure of the brake fluid regulated by the first braking portion 50. The braking device 20 has a redundant configuration in which the first braking portion 50 is on an upstream side and the second braking portion 23 is on a downstream side.

The second braking portion 23 includes two systems of hydraulic circuits 611 and 612. The two wheel cylinders 11 for the front wheels FL and FR are connected to the first hydraulic circuit 611. The two wheel cylinders 11 for the rear wheels RL and RR are connected to the second hydraulic circuit 612.

The first hydraulic circuit 611 is connected to the reservoir tank 24 via the first flow path 331 and the master chamber Rm. In the first hydraulic circuit 611, a first differential pressure adjustment valve 621, which is a normally open linear electromagnetic valve, is provided in a fluid path connecting a connection point with the first flow path 331 and the wheel cylinder 11. A check valve is provided in parallel with the first differential pressure adjustment valve 621 in the fluid path. The check valve allows the brake fluid to flow through the check valve in a direction from the first flow path 331 to the wheel cylinder 11. On the other hand, the check valve restricts the brake fluid from flowing through the check valve in a direction from the wheel cylinder 11 to the first flow path 331.

The second hydraulic circuit 612 is connected to the reservoir tank 24 via the fourth flow path 54, the electric cylinder 51, and the sixth flow path 58. In the second hydraulic circuit 612, a second differential pressure adjustment valve 622, which is a normally open linear electromagnetic valve, is provided in a fluid path connecting a connection point with the sixth flow path 58 and the wheel cylinder 11. A check valve is provided in parallel with the second differential pressure adjustment valve 622 in the fluid path. The check valve allows the brake fluid to flow through the check valve in a direction from the sixth flow path 58 to the wheel cylinder 11. On the other hand, the check valve restricts the brake fluid from flowing through the check valve in a direction from the wheel cylinder 11 to the sixth flow path 58.

The first pump 631 is provided in the first hydraulic circuit 611. The first pump 631 supplies the brake fluid to a fluid path connecting the first differential pressure adjustment valve 621 and the wheel cylinder 11. A check valve is disposed in series between the first pump 631 and the fluid path. The check valve allows the brake fluid to flow in a direction in which the brake fluid is discharged from the first pump 631. On the other hand, the check valve restricts the brake fluid from flowing in a direction in which the brake fluid discharged from the first pump 631 returns to the first pump 631.

The second pump 632 is provided in the second hydraulic circuit 612. The pump 632 supplies the brake fluid to a fluid path connecting the second differential pressure adjustment valve 622 and the wheel cylinder 11. A check valve is disposed in series between the second pump 632 and the fluid path. The check valve allows the brake fluid to flow in a direction in which the brake fluid is discharged from the second pump 632. On the other hand, the check valve restricts the brake fluid from flowing in a direction in which the brake fluid discharged from the second pump 632 returns to the second pump 632.

In the hydraulic circuit 611, the same number of paths 65a and 65b as the wheel cylinders 11 connected to the hydraulic circuit 611 are provided closer to the wheel cylinders 11 than is the first differential pressure adjustment valve 621. Similarly, in the hydraulic circuit 612, the same number of paths 65c and 65d as the wheel cylinders 11 connected to the hydraulic circuit 612 are provided closer to the wheel cylinders 11 than is the second differential pressure adjustment valve 622. Each of the plurality of paths 65a to 65d is provided with a holding valve 66 that is closed when restricting an increase in the hydraulic pressure in the wheel cylinder 11 and a pressure reducing valve 67 that is opened when reducing the hydraulic pressure. That is, the holding valves 66 are disposed in fluid paths closer to the wheel cylinder 11 than the differential pressure adjustment valve 621 and the differential pressure adjustment valve 622. The plurality of holding valves 66 are normally open electromagnetic valves, and the plurality of pressure reducing valves 67 are normally closed electromagnetic valves.

A check valve is provided in parallel with the holding valve 66 in each of the plurality of paths 65a to 65d. The check valve allows the brake fluid to flow through the check valve in a direction from the wheel cylinder 11 to the differential pressure adjustment valves 621 and 622. On the other hand, the check valve restricts the brake fluid from flowing through the check valve in a direction from the differential pressure adjustment valves 621 and 622 to the wheel cylinder 11.

The plurality of hydraulic circuits 611 and 612 are connected to reservoirs 681 and 682 that temporarily store the brake fluid flowing out from the wheel cylinder 11 via the pressure reducing valve 67 when the pressure reducing valve 67 is open. The plurality of reservoirs 681 and 682 are connected to the pumps 631 and 632 via intake flow paths 691 and 692.

The reservoir 681 is connected to a fluid path, which connects the first differential pressure adjustment valve 621 and the master chamber Rm, via a tank-side flow path 701. The reservoir 682 is connected to a fluid path, which connects a connection point with the sixth flow path 58 and the second differential pressure adjustment valve 622 in the second hydraulic circuit 612, via a tank-side flow path 702.

The first pump 631 can pump out the brake fluid in the reservoir tank 24 via the reservoir 681. The first pump 631 discharges the pumped brake fluid to a fluid path between the first differential pressure adjustment valve 621 and the holding valve 66. A fluid path between the fluid path and the first pump 631 is referred to as an “intermediate fluid path 711”.

The second pump 632 can pump out the brake fluid in the reservoir tank 24 via the reservoir 682. The second pump 632 discharges the pumped brake fluid to a fluid path between the second differential pressure adjustment valve 622 and the holding valve 66. A fluid path between the fluid path and the second pump 632 is referred to as an “intermediate fluid path 712”.

### Detection System of Braking Device

As illustrated in FIG. 1, a detection system of the braking device 20 includes a plurality of sensors. Detection signals from the sensors are input to the control device 100 of the braking device 20. In FIG. 1, a master hydraulic pressure sensor 351, an input hydraulic pressure sensor 352, a control pressure sensor 353, a stroke sensor SE1, a temperature sensor SE2, and a vehicle speed detector SE3 are illustrated as the plurality of sensors. The braking device 20 may include a WC pressure sensor SE4 as a sensor.

The master hydraulic pressure sensor 351 detects the hydraulic pressure in the master chamber Rm. For example, the master hydraulic pressure sensor 351 is provided in the first flow path 331. The hydraulic pressure in the master chamber Rm based on a detection value of the master hydraulic pressure sensor 351 is referred to as a “master pressure”.

The input hydraulic pressure sensor 352 detects the hydraulic pressure in the second fluid chamber R2. For example, the input hydraulic pressure sensor 352 is connected to a position between the first control valve 341 and the second fluid chamber R2 in the second flow path 332. The hydraulic pressure in the second fluid chamber R2 based on a detection value of the input hydraulic pressure sensor 352 is referred to as an “input hydraulic pressure”.

The control pressure sensor 353 is a pressure sensor that detects the hydraulic pressure of the brake fluid discharged from the electric cylinder 51. For example, the control pressure sensor 353 is provided near the output port 516 of the electric cylinder 51. As an example, FIG. 1 illustrates a configuration in which the control pressure sensor 353 is connected between the release valve 57 and the output port 516 in the release flow path 56.

The stroke sensor SE1 detects the operation amount of the braking operation member 21. The operation amount of the braking operation member 21 corresponds to a braking force required by the driver. The WC pressure Pwc required by the driver can be calculated based on the operation amount of the braking operation member 21. The WC pressure Pwc required by the driver based on a detection value of the stroke sensor SE1 is referred to as a “required pressure Pr”.

The temperature sensor SE2 detects a temperature of the first electric motor 513. An example of the temperature of the first electric motor 513 is a temperature of the coils in the first electric motor 513. Another example of the temperature of the first electric motor 513 is a temperature of the semiconductor element in the drive circuit provided in the first electric motor 513. The temperature of the semiconductor element is, for example, a temperature of the switching element. The temperature of the first electric motor 513 based on a detection value of the temperature sensor SE2 is referred to as a “motor temperature Tm”.

An example of the vehicle speed detector SE3 is a wheel speed sensor. For example, wheel speed sensors corresponding to each of the wheels are provided. In this case, the vehicle speed detectors SE3 detect wheel speeds of the respective wheels. A vehicle speed can be calculated based on the wheel speeds. The vehicle speed detector SE3 may be a front and rear acceleration sensor. In this case, the vehicle speed detector SE3 detects front and rear accelerations of the vehicle. The vehicle speed can be calculated based on the front and rear accelerations of the vehicle.

The WC pressure sensor SE4 can detect the hydraulic pressure in the wheel cylinder 11. For example, WC pressure sensors SE4 corresponding to the respective wheel cylinders 11 are provided. Alternatively, two sensors, that is, one sensor corresponding to the first wheel cylinders and one sensor corresponding to the second wheel cylinders may be provided as the WC pressure sensor SE4.

### Control Device of Braking Device

The control device 100 can control the various electromagnetic valves 341, 342, 551, 57 and the first electric motor 513 provided in the hydraulic pressure generation device 22 and the various electromagnetic valves 621, 622, 66, 67 and the second electric motor 64 provided in the second braking portion 23.

The control device 100 can operate the braking device 20 based on a braking request. For example, the braking request is generated by the operation of the braking operation member 21 and is canceled when the operation of the braking operation member 21 is canceled. In this case, the control device 100 can operate the braking device 20 using a required braking force calculated based on the operation amount of the braking operation member 21. The braking request may be output by an automated driving control device. In this case, the control device 100 can operate the braking device 20 based on a required braking force calculated by the automated driving control device. A value obtained by converting the required braking force into a target value of the hydraulic pressure in the wheel cylinder 11 corresponds to the required pressure Pr.

The control device 100 sets the required pressure Pr as a target value of the WC pressure Pwc. In this case, the control device 100 operates the braking device 20 to adjust the WC pressure Pwc to the required pressure Pr. Hereinafter, the target value of the WC pressure Pwc may be referred to as a “target WC pressure”. By adjusting the WC pressure Pwc of the wheels FL, FR, RL, and RR based on the target WC pressure, a braking force corresponding to the required braking force is applied to the wheels FL, FR, RL, and RR.

### Adjustment of WC Pressure by First Braking Portion

The control device 100 has a function of controlling the first braking portion 50. The control device 100 can operate the first braking portion 50 to generate a braking force.

The control device 100 can adjust the WC pressure Pwc by operating the electric cylinder 51. Accordingly, the first braking portion 50 can generate a braking force on the wheels FL, FR, RL, and RR of the vehicle. A magnitude of the hydraulic pressure caused by the brake fluid being pressurized by the first braking portion 50 is referred to as a first braking pressure P1. The first braking pressure P1 is equal to a discharge hydraulic pressure of the electric cylinder 51 based on a detection value of the control pressure sensor 353.

When the target WC pressure is increased, the control device 100 controls the electric cylinder 51 such that the master pressure increases to a hydraulic pressure corresponding to the target WC pressure. Specifically, the input port 515 is closed by controlling the first electric motor 513 to move the piston 512 in the forward direction Za. By the movement of the piston 512, the brake fluid is supplied from the output port 516 of the electric cylinder 51 to the fifth flow path 55 via the sixth flow path 58. The brake fluid in the fifth flow path 55 is supplied to the servo chamber Rs of the master cylinder 31. When the brake fluid is supplied to the servo chamber Rs, the master piston 43 moves forward. That is, in the master cylinder 31, the master piston 43 can be moved forward by the brake fluid supplied from the electric cylinder 51 to the servo chamber Rs. Subsequently, the brake fluid is supplied from the master chamber Rm into the wheel cylinders 11 for the front wheels FL and FR via the first hydraulic circuit 611 of the second braking portion 23. As a result, the WC pressure Pwc of the front wheels FL and FR is increased to the target WC pressure. Further, the brake fluid is supplied from the output port 516 of the electric cylinder 51 to the second hydraulic circuit 612 of the second braking portion 23 via the sixth flow path 58. That is, the brake fluid is supplied from the sixth flow path 58 into the wheel cylinders 11 for the rear wheels RL and RR via the second hydraulic circuit 612 of the second braking portion 23. As a result, the WC pressure Pwc of the rear wheels RL and RR is increased to the target WC pressure.

When maintaining the target WC pressure, the control device 100 continues the operation of the electric cylinder 51. As an example, a constant current is continuously applied to the first electric motor 513 so that the piston 512 does not move.

When the target WC pressure is reduced, the control device 100 controls the electric cylinder 51 such that the master pressure is reduced to a hydraulic pressure corresponding to the target WC pressure. Specifically, the hydraulic pressure of the brake fluid supplied to the servo chamber Rs is reduced by controlling the first electric motor 513 to move the piston 512 in the backward direction Zb. When the brake is released, the piston 512 is moved to an initial position to connect the through hole 517 and the input port 515. That is, the input port 515 is opened to connect the hydraulic chamber Re and the reservoir tank 24. As described above, the brake fluid can flow from the servo chamber Rs into the hydraulic chamber Re by moving the piston 512 in the backward direction Zb or connecting the through hole 517 and the input port 515. Then, the master piston 43 moves rearward, and the brake fluid can flow into the master chamber Rm from the wheel cylinders 11 for the front wheels FL and FR via the first hydraulic circuit 611 of the second braking portion 23. As a result, the WC pressure Pwc of the front wheels FL and FR decreases to the target WC pressure. Further, the brake fluid flows from the wheel cylinders 11 for the rear wheels RL and RR into the hydraulic chamber Re via the sixth flow path 58. As a result, the WC pressure Pwc of the rear wheels RL and RR decreases to the target WC pressure.

### Adjustment of WC Pressure by Second Braking Portion

The control device 100 has a function of controlling the second braking portion 23. The control device 100 can operate the second braking portion 23 to generate a braking force.

Hereinafter, an example in which the WC pressure Pwc is adjusted by the second braking portion 23 will be described.

Even when the first braking portion 50 reduces the first braking pressure P1 from a state of generating the predetermined first braking pressure P1, the second braking portion 23 can generate a second braking pressure P2 so as to adjust the WC pressure Pwc to a hydraulic pressure higher than the reduced first braking pressure P1.

When the first braking portion 50 reduces the first braking pressure P1 from the state of generating the predetermined first braking pressure P1, the second braking portion 23 can adjust the second braking pressure P2, which is a differential pressure, by operating the first differential pressure adjustment valve 621 without operating the pump 631. Accordingly, in the braking device 20, the hydraulic pressure of the first hydraulic circuit 611, which is a hydraulic pressure downstream of the first differential pressure adjustment valve 621, can be maintained higher than the first braking pressure P1. Therefore, the WC pressure Pwc in the first wheel cylinders connected to the first hydraulic circuit 611 can be maintained higher than the first braking pressure P1. The hydraulic pressure higher than the first braking pressure P1 can be maintained by adjusting a valve closing force of the first differential pressure adjustment valve 621. The valve closing force of the first differential pressure adjustment valve 621 is a force for closing the first differential pressure adjustment valve 621. The valve closing force of the first differential pressure adjustment valve 621 is adjusted by a current for driving the first differential pressure adjustment valve 621.

When the first braking portion 50 reduces the first braking pressure P1 from the state of generating the predetermined first braking pressure P1, the second braking portion 23 can adjust the second braking pressure P2, which is a differential pressure, by operating the second differential pressure adjustment valve 622 without operating the pump 632. Accordingly, in the braking device 20, the hydraulic pressure of the second hydraulic circuit 612, which is a hydraulic pressure downstream of the second differential pressure adjustment valve 622, can be maintained higher than the first braking pressure P1. Therefore, the WC pressure Pwc in the second wheel cylinders connected to the second hydraulic circuit 612 can be maintained higher than the first braking pressure P1. The hydraulic pressure higher than the first braking pressure P1 can be maintained by adjusting a valve closing force of the second differential pressure adjustment valve 622. The valve closing force of the second differential pressure adjustment valve 622 is a force for closing the second differential pressure adjustment valve 622. The valve closing force of the second differential pressure adjustment valve 622 is adjusted by a current for driving the second differential pressure adjustment valve 622.

The control device 100 can increase the WC pressure Pwc by the differential pressure with respect to the hydraulic pressure of the brake fluid, which is regulated by the first braking portion 50, by generating the differential pressure in the second braking portion 23.

As another example, the control device 100 can adjust the WC pressure Pwc by operating the pumps 631 and 632 according to the driving amount of the second electric motor 64. In this way, the second braking portion 23 can also perform pressurization by the pumps 631 and 632.

### Overheat Restriction Processing

The control device 100 can execute overheat restriction processing when the vehicle is stopped. The overheat restriction processing is executed to restrict a temperature rise of the first electric motor 513 while holding the WC pressure Pwc within a predetermined range when the vehicle is stopped.

The control device 100 uses a first determination value Tmth1 and a second determination value Tmth2 in a flow of processing when executing the overheat restriction processing.

The second determination value Tmth2 is, for example, a value lower by a specified temperature than the motor temperature Tm in a case where the first electric motor 513 is in an overheat state. For example, the second determination value Tmth2 is a value calculated in advance by an experiment or the like as a value indicating a state in which a further rise in the motor temperature Tm is not preferable when the motor temperature Tm is higher than the second determination value Tmth2. An example of the second determination value Tmth2 is a value of 100° C. or more.

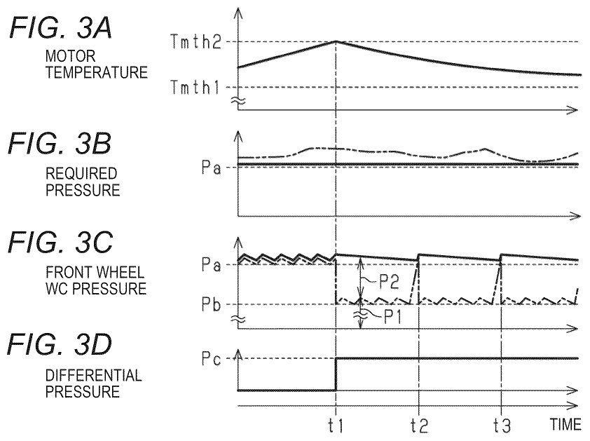

The first determination value Tmthl is set to a value lower than the second determination value Tmth2. The first determination value Tmthl is set, for example, as a value indicating a state in which the motor temperature Tm is high but there is a margin until the first electric motor 513 enters the overheat state when the motor temperature Tm is higher than the first determination value Tmth1. An example of the first determination value Tmthl is a value of 80° C. or more. A relationship between the first determination value Tmth1 and the second determination value Tmth2 is illustrated in of FIG. 3A as described later.

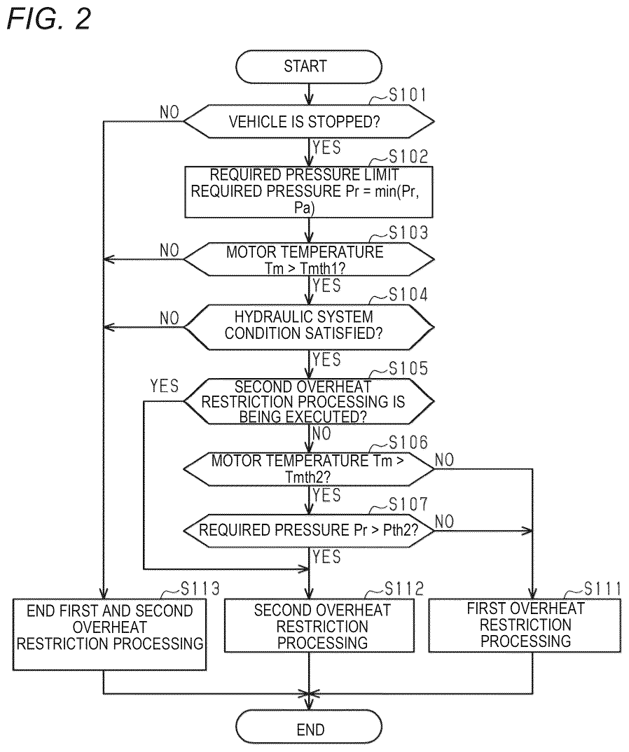

An example of a flow of processing when the control device 100 executes the overheat restriction processing will be described with reference to FIG. 2. For example, the control device 100 repeatedly executes the present processing routine at predetermined intervals.

When the present processing routine is started, first, in step S101, the control device 100 determines whether the vehicle is stopped. For example, when it can be determined that the vehicle is stopped based on the vehicle speed, the control device 100 can determine that the vehicle is stopped. For example, the control device 100 can determine that the vehicle is stopped when the vehicle speed is “0”. For example, the control device 100 can determine that the vehicle is not stopped when the vehicle speed is not “0”.

When the vehicle is not stopped (S101: NO), the control device 100 shifts the processing to step S113. On the other hand, when the vehicle is stopped (S101: YES), the control device 100 shifts the processing to step S102.

In step S102, the control device 100 can limit the required pressure Pr. Specifically, the control device 100 selects a smaller one of the required pressure Pr and a first limit value Pa to update the required pressure Pr. Therefore, when the required pressure Pr is higher than the first limit value Pa, the required pressure Pr is limited to a value equal to the first limit value Pa. On the other hand, when the required pressure Pr is equal to or less than the first limit value Pa, the required pressure Pr is not limited. The required pressure Pr when not limited is a value based on the operation amount of the braking operation member 21. The first limit value Pa is, for example, a minimum value among values that are preferably held as the WC pressure Pwc in order to prevent the vehicle from starting to move from a stopped state. An example of the first limit value Pa is a value of 8 MPa or more. After performing the processing for limiting the required pressure Pr, the control device 100 shifts the processing to step S103.

In step S103, the control device 100 determines whether the motor temperature Tm is higher than the first determination value Tmth1.

When the motor temperature Tm is equal to or lower than the first determination value Tmthl (S103: NO), the control device 100 shifts the processing to step S113. On the other hand, when the motor temperature Tm is higher than the first determination value Tmth1 (S103: YES), the control device 100 shifts the processing to step S104.

In: step S104, the control device 100 determines whether a hydraulic system condition is satisfied.

An example of the hydraulic system condition will be described. For example, when both the following conditions A and B are satisfied, it can be determined that the hydraulic system condition is satisfied.

[Condition A] The required pressure Pr is larger than a first required pressure determination value Pth1.

The first required pressure determination value Pth1 is set to a value calculated in advance by an experiment or the like in order to determine whether the required pressure Pr is a value high enough to require the execution of the overheat restriction processing. The first required pressure determination value Pth1 is set as a value of the required pressure Pr, at which the following can be said, when the required pressure Pr is equal to or less than the first required pressure determination value Pth1. For example, the first required pressure determination value Pthl is set as a value of the required pressure Pr at which the first electric motor 513 does not overheat even if a constant braking force is being continuously generated for a stopped vehicle without executing the overheat restriction processing.

[Condition B] The required pressure Pr does not fluctuate.

For example, the control device 100 can determine that the required pressure Pr does not fluctuate when a fluctuation rate obtained by time-differentiating the required pressure Pr is within a predetermined fluctuation range. For example, when the required pressure Pr is held at a constant value, the control device 100 can also determine that the required pressure Pr does not fluctuate.

The control device 100 may determine that the hydraulic system condition is satisfied when at least one of the condition A and the condition B is satisfied.

The hydraulic system condition may include a condition other than the condition A and the condition B. In this case, the control device 100 may determine that the hydraulic system condition is satisfied when at least one of a plurality of conditions including the condition A and the condition B is satisfied.

The expression “at least one” used in the present specification means “one or more” desired options. As an example, the expression “at least one” used in the present specification means “only one option” or “both of two options” when the number of options is two. As another example, the expression “at least one” used in the present specification means “only one option” or “any combination of two or more options” when the number of options is three or more.

In the processing of step S104, when the hydraulic system condition is not satisfied (S104: NO), the control device 100 shifts the processing to step S113.

On the other hand, when the hydraulic system condition is satisfied (S104: YES), the control device 100 shifts the processing to step S105.

In step S105, the control device 100 determines whether second overheat restriction processing is being executed. The second overheat restriction processing is executed by processing of step S112 described later. When the second overheat restriction processing is being executed (S105: YES), the control device 100 shifts the processing to step S112. On the other hand, when the second overheat restriction processing is not being executed (S105: NO), the control device 100 shifts the processing to step S106.

In step S106, the control device 100 determines whether the motor temperature Tm is higher than the second determination value Tmth2.

When the motor temperature Tm is equal to or lower than the second determination value Tmth2 (S106: NO), the control device 100 shifts the processing to step S111.

On the other hand, when the motor temperature Tm is higher than the second determination value Tmth2 (S106: YES), the control device 100 shifts the processing to step S107.

In: step S107, the control device 100 determines whether the required pressure Pr is larger than a second required pressure determination value Pth2. The second required pressure determination value Pth2 will be described later. Here, the control device 100 performs the determination using the updated required pressure Pr obtained by selecting a smaller value of the required pressure Pr before limitation and the first limit value Pa.

When the required pressure Pr is equal to or less than the second required pressure determination value Pth2 (S107: NO), the control device 100 shifts the processing to step S111.

On the other hand, when the required pressure Pr is larger than the second required pressure determination value Pth2 (S107: YES), the control device 100 shifts the processing to step S112.

In step S111, the control device 100 executes first overheat restriction processing. Thereafter, the control device 100 ends the present processing routine. Details of the first overheat restriction processing will be described later.

In step S112, the control device 100 executes the second overheat restriction processing. Thereafter, the control device 100 ends the present processing routine. Details of the second overheat restriction processing will be described later.

In step S113, the control device 100 ends the first overheat restriction processing and the second overheat restriction processing. Thereafter, the control device 100 ends the present processing routine. That is, when the first overheat restriction processing is being executed, the control device 100 ends the first overheat restriction processing and then ends the present processing routine. When the second overheat restriction processing is being executed, the control device 100 ends the second overheat restriction processing and then ends the present processing routine. When neither the first overheat restriction processing nor the second overheat restriction processing is executed, the control device 100 ends the present processing routine as it is.

As described above, the control device 100 can execute the first overheat restriction processing and the second overheat restriction processing as the overheat restriction processing. The control device 100 executes the first overheat restriction processing when the motor temperature Tm is higher than the first determination value Tmthl and the motor temperature Tm is equal to or lower than the second determination value Tmth2. When the motor temperature Tm is higher than the second determination value Tmth2, the control device 100 executes the second overheat restriction processing. Even in the case where the motor temperature Tm is higher than the second determination value Tmth2, the control device 100 executes the first overheat restriction processing when the required pressure Pr is equal to or less than the second required pressure determination value Pth2.

In the case where an affirmative determination is made in the processing of step S105, that is, in the case where the second overheat restriction processing is already being executed at the time when the processing of step S105 is performed, the control device 100 continues to execute the second overheat restriction processing as the processing of step S112.

The case where a negative determination is made in the processing of step S105 is specifically a case where neither the first overheat restriction processing nor the second overheat restriction processing is being executed at the time when the processing of step S105 is performed, or a case where the first overheat restriction processing is being executed. In the case where neither the first overheat restriction processing nor the second overheat restriction processing is being executed at the time when the processing of step S105 is performed, or in the case where the first overheat restriction processing is being executed, the control device 100 executes the processing of step S106.

The second required pressure determination value Pth2 is set to a value calculated in advance by an experiment or the like. The second required pressure determination value Pth2 is larger than the first required pressure determination value Pth1. For example, the second required pressure determination value Pth2 is a value at which a rise in the motor temperature Tm can be restricted by executing the first overheat restriction processing when the required pressure Pr is equal to or less than the second required pressure determination value Pth2. For example, the second required pressure determination value Pth2 is a value at which the motor temperature Tm continues to rise even if the first overheat restriction processing is executed when the required pressure Pr is larger than the second required pressure determination value Pth2. For example, the second required pressure determination value Pth2 is a value at which overheat of the first electric motor 513 cannot be restricted even if the first overheat restriction processing is executed when the required pressure Pr is larger than the second required pressure determination value Pth2.

The second required pressure determination value Pth2 is smaller than the first limit value Pa. Therefore, when the required pressure Pr is limited to the first limit value Pa as the processing of step S102, the required pressure Pr is larger than the second required pressure determination value Pth2. When the required pressure Pr is smaller than the first limit value Pa, that is, when the required pressure Pr is not limited, the required pressure Pr may be equal to or less than the second required pressure determination value Pth2.

When a negative determination is made in the processing of step S103 and when a negative determination is made in the processing of step S104, the control device 100 generates a braking force corresponding to the required pressure Pr in the stopped vehicle without executing the overheat restriction processing. For example, when the required pressure Pr is held, the control device 100 causes a constant braking force to be generated in the stopped vehicle by continuously applying a current to the first electric motor 513 so that the piston 512 does not move.

### First Overheat Restriction Processing

An example of the first overheat restriction processing will be described.

In the first overheat restriction processing, the control device 100 controls the braking device 20 to adjust the WC pressure Pwc to the required pressure Pr. When the required pressure Pr is limited in step S102, the control device 100 sets the first limit value Pa as the target WC pressure that is a target value for adjusting the WC pressure Pwc. On the other hand, when the required pressure Pr is not limited, the control device 100 sets a value based on the operation amount of the braking operation member 21 as the target WC pressure that is a target value for adjusting the WC pressure Pwc.

In the first overheat restriction processing, the control device 100 controls the first braking portion 50 to generate the first braking pressure P1.

The control device 100 controls the first electric motor 513 to hold the WC pressure Pwc at the target WC pressure. The control device 100 controls the first electric motor 513 to hold the first braking pressure P1 by alternately repeating control of rotating the first electric motor 513 in a first direction and control of rotating the first electric motor 513 in a second direction opposite to the first direction. For example, the first direction corresponds to a direction in which the piston 512 is moved in the forward direction Za. Hereinafter, the control of holding the first braking pressure P1 by the repetition may be referred to as alternating control. By controlling the first electric motor 513 as described above, the piston 512 alternately repeats the movement in the forward direction Za and the movement in the backward direction Zb. As a result, the first braking pressure P1 is held within a predetermined range. The predetermined range is a range corresponding to a range in which the piston 512 reciprocates in the alternating control. The control device 100 holds the WC pressure Pwc in the predetermined range including the target WC pressure by holding the first braking pressure P1. As an example, a lower limit value of the predetermined range is the target WC pressure. As another example, an intermediate value in the predetermined range may be the target WC pressure.

Absolute values of rotation speeds of the first electric motor 513 are equal in the control of rotating the first electric motor 513 in the first direction and the control of rotating the first electric motor 513 in the second direction. A time for continuing the control of rotating the first electric motor 513 in the first direction and a time for continuing the control of rotating the first electric motor 513 in the second direction may be different or equal.

In the first overheat restriction processing, the control device 100 does not generate a differential pressure by the differential pressure adjustment valves 621 and 622. Specifically, the control device 100 does not operate the differential pressure adjustment valves 621 and 622, thereby bringing the differential pressure adjustment valves 621 and 622 into an open state.

### Second Overheat Restriction Processing

An example of the second overheat restriction processing will be described.

In the second overheat restriction processing, the control device 100 controls at least the first differential pressure adjustment valve 621 of the first differential pressure adjustment valve 621 and the second differential pressure adjustment valve 622. Hereinafter, of the first differential pressure adjustment valve 621 and the second differential pressure adjustment valve 622, the differential pressure adjustment valve controlled in the second overheat restriction processing is referred to as a control target valve. That is, as an example, only the first differential pressure adjustment valve 621 is the control target valve. In another example, both the first differential pressure adjustment valve 621 and the second differential pressure adjustment valve 622 are control target valves. The differential pressure adjusted by the control target valve during the execution of the second overheat restriction processing is referred to as a second braking pressure P2.

Of the first hydraulic circuit 611 and the second hydraulic circuit 612, the hydraulic circuit including the control target valve is referred to as a target hydraulic circuit. A target value for holding the WC pressure Pwc in the wheel cylinder connected to the target hydraulic circuit out of the first wheel cylinder and the second wheel cylinder is set as the target WC pressure.

For example, when the first differential pressure adjustment valve 621 is the control target valve, the first hydraulic circuit 611 corresponds to the target hydraulic circuit. When the first differential pressure adjustment valve 621 is the control target valve, the target value of the WC pressure Pwc in the wheel cylinders 11 for the front wheels FL and FR, which are the first wheel cylinders connected to the first hydraulic circuit 611, corresponds to the target WC pressure.

For example, when the second differential pressure adjustment valve 622 is the control target valve, the second hydraulic circuit 612 corresponds to the target hydraulic circuit. When the second differential pressure adjustment valve 622 is the control target valve, the target value of the WC pressure Pwc in the wheel cylinders 11 for the rear wheels RL and RR, which are the second wheel cylinders connected to the second hydraulic circuit 612, corresponds to the target WC pressure.

In the second overheat restriction processing, the control device 100 controls the braking device 20 to adjust the WC pressure Pwc to the required pressure Pr. When the required pressure Pr is limited in step S102, the control device 100 sets the first limit value Pa as the target WC pressure that is a target value for adjusting the WC pressure Pwc. On the other hand, when the required pressure Pr is not limited, the control device 100 sets a value based on the operation amount of the braking operation member 21 as the target WC pressure that is a target value for adjusting the WC pressure Pwc.

In the second overheat restriction processing, the control device 100 controls the first braking portion 50 to generate the first braking pressure P1. In the second overheat restriction processing, the control device 100 controls the second braking portion 23 to generate the second braking pressure P2.

The control device 100 controls the first electric motor 513 to hold the first braking pressure P1 at a value lower than the target WC pressure. For example, the control device 100 holds the first braking pressure P1 at a second limit value Pb. The second limit value Pb is a value smaller than the first limit value Pa. An example of the second limit value Pb is a value smaller than the second required pressure determination value Pth2. For example, the second limit value Pb is a value at which a rise in the motor temperature Tm can be restricted by executing the first overheat restriction processing when the first braking pressure P1 is equal to or less than the second limit value Pb. An example of the second limit value Pb is a value larger than the first required pressure determination value Pth1. An example of the second limit value Pb is a value of 5 MPa or less.

The control device 100 alternately repeats control of rotating the first electric motor 513 in the first direction and control of rotating the first electric motor 513 in the second direction opposite to the first direction, so as to hold the first braking pressure P1 at the second limit value Pb. That is, the control device 100 performs alternating control to hold the first braking pressure P1 at the second limit value Pb. The control of rotating the first electric motor 513 in the first direction and the control of rotating the first electric motor 513 in the second direction are common to the alternating control in the first overheat restriction processing except that the target of the first braking pressure P1 is different.

The control device 100 operates a control target valve of the differential pressure adjustment valves 621 and 622. At this time, the control device 100 operates the control target valve without operating the pumps 631 and 632. The control device 100 adjusts a valve closing force of the control target valve to generate the second braking pressure P2 such that the target WC pressure is satisfied by a sum of the first braking pressure P1 and the second braking pressure P2.

For example, when both the first differential pressure adjustment valve 621 and the second differential pressure adjustment valve 622 are control target valves, the following is performed. The control device 100 generates the second braking pressure P2 such that both the WC pressure Pwc in the first wheel cylinders and the WC pressure Pwc in the second wheel cylinders satisfy the target WC pressure by the sum of the first braking pressure Pl and the second braking pressure P2.

On the other hand, the control device 100 does not operate the differential pressure adjustment valve that is not the control target valve. Specifically, when only the first differential pressure adjustment valve 621 is the control target valve, the WC pressure Pwc in the second wheel cylinders is controlled to the first braking pressure P1. That is, the WC pressure Pwc in the wheel cylinders 11 for the rear wheels RL and RR is controlled to the first braking pressure P1.

In the second overheat restriction processing, for example, the control device 100 operates the control target valve at the same time as starting the alternating control. Alternatively, the control device 100 start the alternating control after operating the control target valve. Here, “operating the control target valve at the same time as starting the alternating control” means that, when starting the alternating control for holding the first braking pressure P1 at the second limit value Pb, the control target valve is operated before the first braking pressure P1 starts to decrease. Therefore, a difference between a timing of switching the control of the first electric motor 513 to decrease the first braking pressure Pl to the second limit value Pb and a timing of operating the control target valve is allowed until the first braking pressure P1 starts to decrease.

The control device 100 may temporarily increase the first braking pressure P1 to the target WC pressure or higher when a predetermined condition is satisfied during the execution of the second overheat restriction processing. After the first braking pressure P1 is temporarily increased, it is preferable to quickly decrease the first braking pressure P1 to the second limit value Pb.

As an example, the control device 100 can determine that, each time a specified time elapses from the start of the second overheat restriction processing, the predetermined condition is satisfied. In this case, the control device 100 periodically increases the first braking pressure P1 during the execution of the second overheat restriction processing.

For example, when the WC pressure Pwc of the wheel cylinders 11 connected to the target hydraulic circuit becomes smaller than a WC pressure threshold Pwth, it can be determined that the predetermined condition is satisfied. In this case, the control device 100 increases the first braking pressure P1 at a timing when the WC pressure Pwc decreases during the execution of the second overheat restriction processing. As a result, the timing of increasing the first braking pressure P1 may be non-periodical.

The WC pressure Pwc can be acquired based on, for example, a detection value of the WC pressure sensor SE4. An example of the WC pressure threshold Pwth is a value obtained by multiplying the target WC pressure by a coefficient smaller than “1.00”. The coefficient is not particularly limited. As the coefficient, for example, a value in a range of 0.90 or more and 0.99 or less can be adopted.

### According to the Second Overheat Restriction

processing, for example, when the overheat restriction processing shifts from the first overheat restriction processing to the second overheat restriction processing, the hydraulic pressure in the target hydraulic circuit can be adjusted to be higher than the first braking pressure P1. According to the second overheat restriction processing, for example, by temporarily increasing the first braking pressure P1 to the target WC pressure or higher when starting the second overheat restriction processing, the hydraulic pressure in the target hydraulic circuit can be adjusted to be higher than the first braking pressure P1 even if the first braking pressure P1 is low at the start of the second overheat restriction processing. In the case of adopting a configuration in which the first braking pressure P1 is temporarily increased when starting the second overheat restriction processing, it is preferable to quickly decrease the first braking pressure P1 to the second limit value Pb after the first braking pressure P1 is increased.

### Operations and Effects

Operations and effects of the embodiment will be described.

An example in which the control device 100 performs the overheat restriction processing in the braking device 20 will be described with reference to FIGS. 3A-3D. FIGS. 3A-3D illustrate an example in which only the first differential pressure adjustment valve 621 is set as the control target valve in the second overheat restriction processing.

In the example illustrated in FIGS. 3A-3D, before a timing t1, the vehicle is stopped and the hydraulic system condition is satisfied. In the example illustrated in FIGS. 3A-3D, this state continues.

As illustrated in FIG. 3A, the motor temperature Tm is higher than the first determination value Tmthl before the timing t1. The motor temperature Tm continues to increase before the timing t1. The motor temperature Tm is higher than the second determination value Tmth2 at the timing t1.

In FIG. 3B, the required pressure Pr before limitation is indicated by a two-dot chain line. The required pressure Pr before limitation indicated by the two-dot chain line changes over time as values larger than the first limit value Pa. Therefore, the required pressure Pr after limitation is limited to the first limit value Pa. In FIG. 3B, the required pressure Pr after limitation is indicated by a solid line. Since the first limit value Pa is larger than the second required pressure determination value Pth2, the required pressure Pr after limitation changes over time as values larger than the second required pressure determination value Pth2.

Since the state is as described above, in the example illustrated in FIGS. 3A-3D, the first overheat restriction processing is executed before the timing t1 (S111). Therefore, as illustrated in FIG. 3C, the WC pressure Pwc of the front wheels FL and FR is limited to the first limit value Pa by the first overheat restriction processing.

More specifically, before the timing t1, the alternating control is performed to hold the first braking pressure P1 indicated by the two-dot chain line in FIG. 3C at the first limit value Pa. At this time, since the first overheat restriction processing is executed, the differential pressure due to the control of the differential pressure adjustment valve is not generated as illustrated in FIG. 3D. As a result, before the timing t1, the WC pressure Pwc of the front wheels FL and FR is equal to the first braking pressure P1. As indicated by a solid line in FIG. 3C, the WC pressure Pwc of the front wheels FL and FR is held at the first limit value Pa, similarly to the first braking pressure P1 indicated by the two-dot chain line. In detail, before the timing t1 in FIG. 3C, the solid line indicating the WC pressure Pwc of the front wheels FL and FR and the two-dot chain line indicating the first braking pressure P1 change over time so as to overlap each other.

When the motor temperature Tm becomes higher than the second determination value Tmth2 at the timing t1, an affirmative determination is made in the processing of step S106 in FIG. 2. Therefore, the second overheat restriction processing is executed (S112). In the example illustrated in FIGS. 3A-3D, since the first overheat restriction processing is executed before the timing t1, the overheat restriction processing shifts from the first overheat restriction processing to the second overheat restriction processing at the timing t1.

By executing the second overheat restriction processing, the first braking pressure P1 decreases to the second limit value Pb as indicated by the two-dot chain line in FIG. 3C. Thereafter, the alternating control is performed to hold the first braking pressure P1 at the second limit value Pb. At this time, since the first differential pressure adjustment valve 621 is operated, the second braking pressure P2 is generated. The first differential pressure adjustment valve 621 is controlled to generate a differential pressure at which the sum of the first braking pressure P1 and the second braking pressure P2 satisfies the first limit value Pa. In FIG. 3D, a magnitude of the differential pressure that can be generated by the first differential pressure adjustment valve 621 is indicated as “Pc”. In FIG. 3D, the magnitude of the differential pressure in which a holding leakage of the First differential pressure adjustment valve 621 is not considered is shown. Therefore, the magnitude of the differential pressure shown in FIG. 3D does not coincide with a magnitude of an actually generated differential pressure. The magnitude of the differential pressure when the holding leakage is not considered corresponds to a value (Pc=Pa−Pb) obtained by subtracting the second limit value Pb from the first limit value Pa. As a result of the generation of the differential pressure, from the timing tl onward, the WC pressure Pwc of the front wheels FL and FR is equal to the sum of the first braking pressure P1 and the second braking pressure P2. As indicated by the solid line in FIG. 3C, the WC pressure Pwc of the front wheels FL and FR is held at the first limit value Pa.

In the example illustrated in FIGS. 3A-3D, a period from the timing t1 to a timing t2 corresponds to the specified time. Therefore, as indicated by the two-dot chain line in FIG. 3C, the first braking pressure P1 is temporarily increased to the first limit value Pa or more, which is the target WC pressure, at the timing t2. Thereafter, after the first braking pressure P1 is reduced to the second limit value Pb, the alternating control for holding the first braking pressure P1 at the second limit value Pb is resumed. The control of temporarily increasing the first braking pressure P1 in this manner is periodically performed every time the specified time elapses during the execution of the second overheat restriction processing. For example, at a timing t3, the first braking pressure P1 is also temporarily increased to the first limit value Pa or more.

By executing the second overheat restriction processing from the timing t1 onward, a load on the first electric motor 513 is reduced. Therefore, the rise in the motor temperature Tm is restricted from the timing tl onward. In FIG. 3A, an example in which the motor temperature Tm starts to gradually decrease from the timing t1 onward is illustrated. From the timing t1 onward, the motor temperature Tm changes in a range of values higher than the first determination value Tmthl and lower than the second determination value Tmth2.

According to the braking device 20, the control device 100 executes the overheat restriction processing to drive the first electric motor 513 by the alternating control. Therefore, the load can be distributed to the three phases of the first electric motor 513. Accordingly, overheat of a specific phase of the first electric motor 513 can be restricted.

According to the braking device 20, the control device 100 executes the overheat restriction processing, whereby a temperature rise of the switching element provided in the first electric motor 513 can be restricted. Similarly, a temperature rise of the coils of the first electric motor 513 can be restricted.

In particular, in the second overheat restriction processing executed by the control device 100, the hydraulic pressure held by the alternating control can be reduced to a value obtained by subtracting the second braking pressure P2 from the target WC pressure. By reducing the hydraulic pressure held by the electric cylinder 51 to be low, it is possible to restrict the temperature rise of the first electric motor 513 even when a state in which the hydraulic pressure in the wheel cylinder 11 is held high continues. Therefore, overheat of the first electric motor 513 can be restricted. For example, it was confirmed that even when the first limit value Pa is set to a value of 8 MPa or more, a state in which the WC pressure Pwc is held at the first limit value Pa while restricting overheat of the first electric motor 513 can be continued for 4000 seconds or longer. According to the control device 100, even when a high WC pressure Pwc is required to secure a large braking force in a stopped vehicle, overheat of the first electric motor 513 can be restricted.

According to the braking device 20, compared to a case where the target WC pressure is held only by the second braking pressure P2 without generating the first braking pressure P1, the load applied to the control target valve can be reduced by the control device 100 executing the second overheat restriction processing. Therefore, a temperature rise of the control target valve can be restricted. Accordingly, overheat of the control target valve can be restricted.

In a case where the hydraulic pressure in the wheel cylinder 11 is held so as to satisfy the target WC pressure by the sum of the first braking pressure P1 and the second braking pressure P2, the second braking pressure P2 may decrease due to a minute holding leakage of the control target valve when the time for continuing the state of holding the hydraulic pressure increases. For example, even when the control target valve is closed, leakage may occur and the brake fluid may pass through the control target valve. If the second braking pressure P2 decreases during the execution of the second overheat restriction processing, the WC pressure Pwc may decrease as the second braking pressure p2 decreases.

Therefore, in the braking device 20 of the embodiment, the first braking pressure P1 is temporarily increased to the target WC pressure or higher when the predetermined condition is satisfied. By increasing the first braking pressure P1 in this way, the target WC pressure can be temporarily satisfied only by the first braking pressure P1. In FIG. 3C, an example is illustrated in which the WC pressure Pwc indicated by the solid line that gradually decreases is repeatedly pushed up by the temporary increase of the first braking pressure P1 indicated by the two-dot chain line. As described above, according to the braking device 20, even if the WC pressure Pwc gradually decreases due to a temporary decrease in the second braking pressure P2 during the execution of the second overheat restriction processing, the WC pressure Pwc is increased by the increase in the first braking pressure P1, whereby the target WC pressure can be continuously maintained. Accordingly, the WC pressure Pwc can be held for a longer time.

For example, in the example illustrated in FIGS. 3A-3D, the WC pressure Pwc of the wheel cylinders 11 for the front wheels FL and FR, that is, the first wheel cylinders is held by setting only the first differential pressure adjustment valve 621 as the control target valve. On the other hand, the WC pressure Pwc of the wheel cylinders 11 for the rear wheels RL and RR, that is, the second wheel cylinders is lower than the WC pressure Pwc of the first wheel cylinders by comparison. In the example described with reference to FIGS. 3A-3D, the change over time of the WC pressure Pwc in the wheel cylinders 11 for the rear wheels RL and RR coincides with the change over time of the first braking pressure P1 indicated by the two-dot chain line in FIG. 3C. For example, when the first overheat restriction processing shifts to the second overheat restriction processing, the braking force generated on the rear wheels RL and RR decreases according to the decrease in the WC pressure Pwc. If a comparative example in which only the second differential pressure adjustment valve 622 is set as the control target valve is considered, the braking force generated on the front wheels FL and FR decreases according to the decrease in the WC pressure Pwc when the first overheat restriction processing shifts to the second overheat restriction processing. As described above, when one of the first differential pressure adjustment valve 621 and the second differential pressure adjustment valve 622 is set as the control target valve, the braking force of one of the front wheels FL and FR and the rear wheels RL and RR can be held, but the braking force of the other decreases. When the braking force of the front wheels FL and FR or the rear wheels RL and RR decreases, the braking force of the entire vehicle decreases.

According to the braking device 20, in particular, when only the first differential pressure adjustment valve 621 is set as the control target valve, the following effects are achieved. In the embodiment, in the case where only the first differential pressure adjustment valve 621 is set as the control target valve, it is possible to reduce a decrease in the braking force of the entire vehicle when the second overheat restriction processing is executed, as compared with the comparative example in which only the second differential pressure adjustment valve 622 is set as the control target valve. Specifically, in the embodiment, compared to the magnitude of the braking force generated for the WC pressure Pwc in the rear-wheel braking mechanisms 10B, the magnitude of the braking force generated for the same WC pressure Pwc in the front-wheel braking mechanisms 10A is larger. Therefore, even if the WC pressure Pwc in the wheel cylinders 11 for the rear wheels RL and RR decreases, the WC pressure Pwc in the wheel cylinders 11 for the front wheels FL and FR is held, so that a decrease width of the braking force of the entire vehicle can be reduced to be small. As described above, according to the control device 100, it is easy to secure the braking force while restricting overheat of the first electric motor 513 by executing the second overheat restriction processing.

In the above description, an example in which only the first differential pressure adjustment valve 621 is set as the control target valve in the second overheat restriction processing has been described. In the embodiment, the control device 100 provided in the braking device 20 sets at least the first differential pressure adjustment valve 621 of the first differential pressure adjustment valve 621 and the second differential pressure adjustment valve 622 as the control target valve in the second overheat restriction processing. When only the first differential pressure adjustment valve 621 is set as the control target valve, as described above, the WC pressure Pwc of the first wheel cylinders can be held at the first limit value Pa while restricting overheat of the first electric motor 513. When the second differential pressure adjustment valve 622 is also set as the control target valve in the second overheat restriction processing, the braking device 20 can also hold the WC pressure Pwc of the second wheel cylinders while restricting overheat of the first electric motor 513. In this case, the braking device 20 can hold the WC pressure Pwc of the second wheel cylinders at the first limit value Pa in addition to the WC pressure Pwc of the first wheel cylinders.

In the embodiment, before it is determined whether the hydraulic system condition is satisfied as the processing of step S104, the processing of limiting the required pressure Pr is performed (S102). Therefore, when the required pressure Pr is limited to the first limit value Pa, the hydraulic system condition is likely to be satisfied. This is because the condition B of the hydraulic system condition is always satisfied when the required pressure Pr is limited to the first limit value Pa.

### (Modifications)

The embodiment can be modified and implemented as follows. The embodiment and the following modifications can be implemented in combination with each other within a technically consistent range.

. In the above embodiment, an example is illustrated in which a value based on the detection value of the temperature sensor SE2 is adopted as the motor temperature Tm. An estimated value may be adopted as the motor temperature Tm. For example, the motor temperature Tm can be estimated from a current value of the first electric motor 513, a time during which the first electric motor 513 continues to perform driving, and the like.
In the above embodiment, in the processing of step S103 described with reference to FIG. 2, the determination is performed using the motor temperature Tm.

Alternatively, the determination may be performed using a time during which stop of the vehicle continues. When the WC pressure Pwc is held to secure the braking force in the stopped vehicle, it can be estimated that the motor temperature Tm is likely to increase as the time during which the stop of the vehicle continues increases. Therefore, in the processing of step S103, an affirmative determination may be made when the time during which the stop of the vehicle continues is longer than a specified first determination time. In this case, a negative determination is made when the time during which the stop of the vehicle continues is equal to or less than the first determination time.

Similarly to the processing of step s103, in the processing of step S106, the determination may be performed using the time during which the stop of the vehicle continues. For example, in the processing of step S106, an affirmative determination may be made when the time during which the stop of the vehicle continues is longer than a specified second determination time. In this case, a negative determination is made when the time during which the stop of the vehicle continues is equal to or less than the second determination time. The second determination time is longer than the first determination time.
In the above embodiment, an example is illustrated in which the processing of step S102 is executed when an affirmative determination is made in the processing of step S101. Alternatively, when an affirmative determination is made in the processing of step S101, the processing may proceed to step S103. In this case, the control device 100 may perform processing described as the processing of step S102 in the subsequent flow of processing. For example, the processing that can limit the required pressure Pr, which is the processing described as step S102, may be performed before the processing of step S104 is performed when an affirmative determination is made in the processing of step S103. For example, the processing that can limit the required pressure Pr may be performed before the processing of step S105 is performed when an affirmative determination is made in the processing of step S104. For example, the processing that can limit the required pressure Pr may be performed immediately before performing the processing of step S111. For example, the processing that can limit the required pressure Pr may be performed immediately before performing the processing of step S112. As described above, the processing that can limit the required pressure Pr may be performed before performing the first overheat restriction processing or the second overheat restriction processing.
In the above embodiment, as an example of limiting the required pressure Pr, a configuration is illustrated in which the smaller one of the required pressure Pr and the first limit value Pa is selected to update the required pressure Pr. Alternatively, the control device 100 may hold the required pressure Pr before limitation and the required pressure Pr after limitation.
When the configuration in which only the first differential pressure adjustment valve 621 is set as the control target valve is adopted, the second braking portion 23 may have any configuration described below. The second braking portion 23 may not include the second differential pressure adjustment valve 622. The second braking portion 23 may not include the various electromagnetic valves 66 and 67 disposed in the second hydraulic circuit 612. The second braking portion 23 may not include the second hydraulic circuit 612.
When the configuration in which only the first differential pressure adjustment valve 621 is set as the control target valve is adopted, the second braking portion 23 may not be interposed between the second wheel cylinders and the first braking portion 50. In this case, the brake fluid is directly supplied from the first braking portion 50 to the second wheel cylinders.
In the above embodiment, the first hydraulic circuit 611 is connected to the first flow path 331, and the second hydraulic circuit 612 is connected to the sixth flow path 58. Alternatively, a configuration in which the first hydraulic circuit 611 is connected to the sixth flow path 58 and the second hydraulic circuit 612 is connected to the first flow path 331 may be adopted.
In the above embodiment, the left front wheel FL and the right front wheel FR correspond to the first wheels, and the left rear wheel RL and the right rear wheel RR correspond to the second wheels.

Alternatively, the right front wheel FR and the left rear wheel RL may correspond to the first wheels, and the left front wheel FL and the right rear wheel RR may correspond to the second wheels. In this case, the wheel cylinder 11 corresponding to the right front wheel FR and the wheel cylinder 11 corresponding to the left rear wheel RL are first wheel cylinders. The wheel cylinder 11 corresponding to the left front wheel FL and the wheel cylinder 11 corresponding to the right rear wheel RR are second wheel cylinders. The wheel cylinder 11 corresponding to the right front wheel FR and the wheel cylinder 11 corresponding to the left rear wheel RL are connected to the first hydraulic circuit. The wheel cylinder 11 corresponding to the left front wheel FL and the wheel cylinder 11 corresponding to the right rear wheel RR are connected to the second hydraulic circuit.

The control by the control device 100 can be applied to the vehicle and the braking device having the above configurations. That is, the overheat restriction processing executed by the control device 100 can be applied. As an example, in the above configuration, when the second overheat restriction processing is executed with at least the first differential pressure adjustment valve as the control target valve, both the WC pressure Pwc of the right front wheel FR and the WC pressure Pwc of the left rear wheel RL are held at the target WC pressure by the sum of the first braking pressure P1 and the second braking pressure P2. When the second overheat restriction processing is executed with only the first differential pressure adjustment valve of the first differential pressure adjustment valve and the second differential pressure adjustment valve as the control target valve, the WC pressure Pwc of the left front wheel FL and the WC pressure Pwc of the right rear wheel RR are equal to the first braking pressure P1.
The left rear wheel RL and the right rear wheel RR may correspond to the first wheels, and the left front wheel FL and the right front wheel FR may correspond to the second wheels. The overheat restriction processing executed by the control device 100 can also be applied to the vehicle and the braking device having the above configurations.
The left front wheel FL and the right rear wheel RR may correspond to the first wheels, and the right front wheel FR and the left rear wheel RL may correspond to the second wheels. The overheat restriction processing executed by the control device 100 can also be applied to the vehicle and the braking device having the above configurations.
In the above embodiment, the WC pressure Pwc required by the driver based on the detection value of the stroke sensor SE1 is set as the “required pressure Pr”. Alternatively, the required braking force may be calculated by an automated driving control device, and the required pressure Pr may be a value obtained by converting the required braking force into a target value of the hydraulic pressure in the wheel cylinders 11.
The processing circuit such as the control device 100 can be implemented as follows. The processing circuit can be implemented as a circuit including one or more processors that execute various types of processing according to a computer program. The processing circuit can be implemented as a circuit including one or more hardware circuits that execute various types of processing. The processing circuit can be implemented as a circuit in which one or more processors that execute some of the various types of processing and one or more hardware circuits that execute the remaining processing of the various types of processing are combined.

The processor includes a processing device such as a CPU. The processor includes a memory such as a RAM and a ROM. The memory stores a program code or a command configured to cause the processing device to execute processing. The memory, that is, a storage medium includes any available medium that can be accessed by a general-purpose or dedicated computer. Examples of the hardware circuit include an application-specific integrated circuit (ASIC). Another example of the hardware circuit is an FPGA.

1. A braking device to be applied to a vehicle including a first wheel cylinder, a second wheel cylinder, a first wheel that generates a friction braking force corresponding to a hydraulic pressure in the first wheel cylinder, and a second wheel that generates a friction braking force corresponding to a hydraulic pressure in the second wheel cylinder, the braking device comprising:
a reservoir tank configured to store a brake fluid;
a first braking portion including an electric cylinder including a cylinder, a piston, and an electric motor, and configured to adjust the hydraulic pressure in the first wheel cylinder and the hydraulic pressure in the second wheel cylinder by discharging the brake fluid, which is supplied from the reservoir tank, by the piston that moves in accordance with driving of the electric motor;
a second braking portion interposed between the first wheel cylinder and the first braking portion and configured to adjust the hydraulic pressure in the first wheel cylinder by the brake fluid supplied from the first braking portion; and
a control device configured to control the first braking portion and the second braking portion, wherein
a magnitude of a hydraulic pressure due to pressurization of the brake fluid by the first braking portion is set as a first braking pressure,
the second braking portion includes
a hydraulic circuit connected to the first wheel cylinder, and
a differential pressure adjustment valve that is disposed in a flow path connecting the first braking portion and the hydraulic circuit, is a normally open electromagnetic valve that adjusts a differential pressure between the first braking pressure and a hydraulic pressure in the hydraulic circuit, and is configured to adjust the hydraulic pressure in the hydraulic circuit to be higher than the first braking pressure,
when the vehicle is stopped, with a target value for holding the hydraulic pressure in the first wheel cylinder set as a target WC pressure and a differential pressure adjusted by the differential pressure adjustment valve set as a second braking pressure, the control device executes overheat restriction processing of alternately repeating control of rotating the electric motor in a first direction and control of rotating the electric motor in a second direction opposite to the first direction so as to hold the first braking pressure at a value lower than the target WC pressure and adjusting a valve closing force of the differential pressure adjustment valve to generate the first braking pressure and the second braking pressure so as to satisfy the target WC pressure by a sum of the first braking pressure and the second braking pressure.

2. The braking device according to claim 1, wherein
the control device temporarily increases the first braking pressure to the target WC pressure or higher when a predetermined condition is satisfied during execution of the overheat restriction processing.

3. The braking device according to claim 1, wherein
the second braking portion is interposed between the first wheel cylinder and the first braking portion and between the second wheel cylinder and the first braking portion, and is configured to adjust the hydraulic pressure in the first wheel cylinder and the hydraulic pressure in the second wheel cylinder by the brake fluid supplied from the first braking portion,
the hydraulic circuit is a first hydraulic circuit,
the differential pressure adjustment valve is a first differential pressure adjustment valve,
the second braking portion further includes
a second hydraulic circuit connected to the second wheel cylinder, and
a second differential pressure adjustment valve that is disposed in a flow path connecting the first braking portion and the second hydraulic circuit, that is a normally open electromagnetic valve configured to adjust a differential pressure between the first braking pressure and the hydraulic pressure in the second hydraulic circuit, and that is configured to adjust the hydraulic pressure in the second hydraulic circuit to be higher than the first braking pressure,
setting at least the first differential pressure adjustment valve of the first differential pressure adjustment valve and the second differential pressure adjustment valve as a control target valve, setting a hydraulic circuit including the control target valve out of the first hydraulic circuit and the second hydraulic circuit as a target hydraulic circuit, setting a target value for holding a hydraulic pressure in a wheel cylinder connected to the target hydraulic circuit out of the first wheel cylinder and the second wheel cylinder as the target WC pressure, and setting a differential pressure adjusted by the control target valve as the second braking pressure, the control device executes the overheat restriction processing of alternately repeating the control of rotating the electric motor in the first direction and the control of rotating the electric motor in the second direction so as to hold the first braking pressure at a value lower than the target WC pressure and adjusting a valve closing force of the control target valve to generate the first braking pressure and the second braking pressure so as to satisfy the target WC pressure by a sum of the first braking pressure and the second braking pressure.

4. The braking device according to claim 1, wherein
the second braking portion is interposed between the first wheel cylinder and the first braking portion and between the second wheel cylinder and the first braking portion, and is configured to adjust the hydraulic pressure in the first wheel cylinder and the hydraulic pressure in the second wheel cylinder by the brake fluid supplied from the first braking portion,
the hydraulic circuit is a first hydraulic circuit,
the differential pressure adjustment valve is a first differential pressure adjustment valve,
the second braking portion further includes
a second hydraulic circuit connected to the second wheel cylinder, and
a second differential pressure adjustment valve that is disposed in a flow path connecting the first braking portion and the second hydraulic circuit, that is a normally open electromagnetic valve configured to adjust a differential pressure between the first braking pressure and the hydraulic pressure in the second hydraulic circuit, and that is configured to adjust the hydraulic pressure in the second hydraulic circuit to be higher than the first braking pressure,
setting at least the first differential pressure adjustment valve of the first differential pressure adjustment valve and the second differential pressure adjustment valve as a control target valve, setting a hydraulic circuit including the control target valve out of the first hydraulic circuit and the second hydraulic circuit as a target hydraulic circuit, setting a target value for holding a hydraulic pressure in a wheel cylinder connected to the target hydraulic circuit out of the first wheel cylinder and the second wheel cylinder as the target WC pressure, and setting a differential pressure adjusted by the control target valve as the second braking pressure, the control device executes the overheat restriction processing of alternately repeating the control of rotating the electric motor in the first direction and the control of rotating the electric motor in the second direction so as to hold the first braking pressure at a value lower than the target WC pressure and adjusting a valve closing force of the control target valve to generate the first braking pressure and the second braking pressure so as to satisfy the target WC pressure by a sum of the first braking pressure and the second braking pressure.
